(19) United States
(12) Patent Application Publication
(10) Pub. No.: US 2007/0065118 A1
(43) Pub. Date: Mar. 22, 2007

(54) Data recording methods and systems for rewritable disks

(75) Inventor: Hsien-Yung Chen, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/231,228

(22) Filed: Sep. 20, 2005

(51) Int. Cl. H04N 5/00

(52) U.S. Cl. 386/125

(57) ABSTRACT

A data recording method for rewritable disks. A title start address of a rewritable disk is determined. The rewritable disk includes a file system area, an management information area, a data recovery area, and VOBs. An indication is written to the data recovery area based on the title start address. Next, multimedia data is recorded to the VOBs. The indication is deleted from the data recovery area if the multimedia data recording has finished. Management information is recorded to the management information area and the file system area.

### BACKGROUND

The invention relates to data recording methods, and in particular to data recording methods and systems for rewritable disks.

With the progress of disk recording technology, compact disks (CDs) may not satisfy multimedia storage capacity requirements. Digital versatile disks (DVDs) with higher storage density are thus provided. Recently, rewritable disks, such as DVD−RW or DVD+RW disks according to DVD−RW or DVD+RW standards, allowing repeat recording data, are commonly used.

FIG. 1 illustrates a conventional data recording procedure for rewritable disks. When a disk is recorded, a title start address is determined (step S100). Multimedia data is recorded on the disk according to the title start address (step S102). If the multimedia data recording is finished (step S104), management information is generated and recorded onto the disk (step S106). The management information can be information files containing recording-related information, such as recording time, or recording date.

FIG. 2 illustrates an exemplary format of a rewritable disk. A rewritable disk 200 of DVD+RW or DVD−RW standards includes a file system area 202, a management information area 204, and several video object sets (VOBs) 208. The management information generated in step S106 is stored in the file system area 202 and the management information area 204. Multimedia data is recorded in the VOBs 208. Here, area 206 is an unused area on the rewritable disk 200. The unused area 206 can be used to record user-defined information or other recording information according to the DVD−RW or DVD+RW standards.

Multimedia data is stored in video object sets (VOB). A VOB 208 includes multiple video object units (VOBUs) 300. FIG. 3 illustrates an exemplary format of a VOBU. Each VOBU 300 has several packs 302, including navigation pack (NV_PCK) 304, video pack (V_PCK) 305, audio pack (A_PCK) 306, and sub-picture pack (SP_PCK) 307. FIG. 4 illustrates an exemplary format of a navigation pack 304. The navigation pack 304 includes program control information (PCI_PKT) 400 for production control, and data search information (DSI_PKT) 402 for special reproduction, as shown in FIG. 4. PCI_PKT 400 and DSI_PKT 402 contain pack information, such as VOBU relative end address (VOBU_EA) 404, VOBU start PTM (VOBU_S_PTM) 406, and VOBU end PTM (VOBU_E_PTM) 408.

If multimedia data is completely recorded onto the disk, a title and related information would be generated and recorded into the file system area 202 and management information area 204 on the disk. When an unexpected recording termination occurs (for example, due to power failure), the information recorded in the file system area 202 and management information area 204 cannot match the recorded video data in the VOBs 208. Thus, the recorded multimedia data cannot be properly reproduced because the title and related information are not complete.

Therefore, a title and related information recovery method for data recording on disks is desirable.

### SUMMARY

In an exemplary embodiment of data recording methods for rewritable disks, a title start address of a rewritable disk is determined. The rewritable disk comprises a file system area, a management information area, a data recovery area, and VOBs. An indication is written to the data recovery area based on the title start address. Multimedia data is recorded to the VOBs. The indication is deleted from the data recovery area if the multimedia data recording is finished. Management information is recorded to the file system area and the management information area.

### DESCRIPTION OF THE DRAWINGS

The invention can be more fully understood by reading the subsequent detailed description and examples with references made to the accompanying drawings, wherein:

FIG. 1 illustrates a conventional data recording procedure for rewritable disks.

FIG. 2 illustrates an exemplary format of a rewritable disk.

FIG. 3 illustrates an exemplary format of a VOBU.

FIG. 4 illustrates an exemplary format of a navigation pack.

FIG. 5 is a flowchart of an embodiment of a data recording method for rewritable disks.

FIG. 6 is a flowchart of an embodiment of a data recovery method for rewritable disks.

FIG. 7 is a diagram of an embodiment of a data recording system for rewritable disks.

FIG. 8 is a detailed diagram of an embodiment of a recording subsystem of a data recording system.

FIG. 9 is a detailed diagram of an embodiment of a recovery subsystem of a data recording system.

FIG. 10 is a detailed diagram of an embodiment of an execution module of a recovery subsystem of a data recording system.

### DESCRIPTION

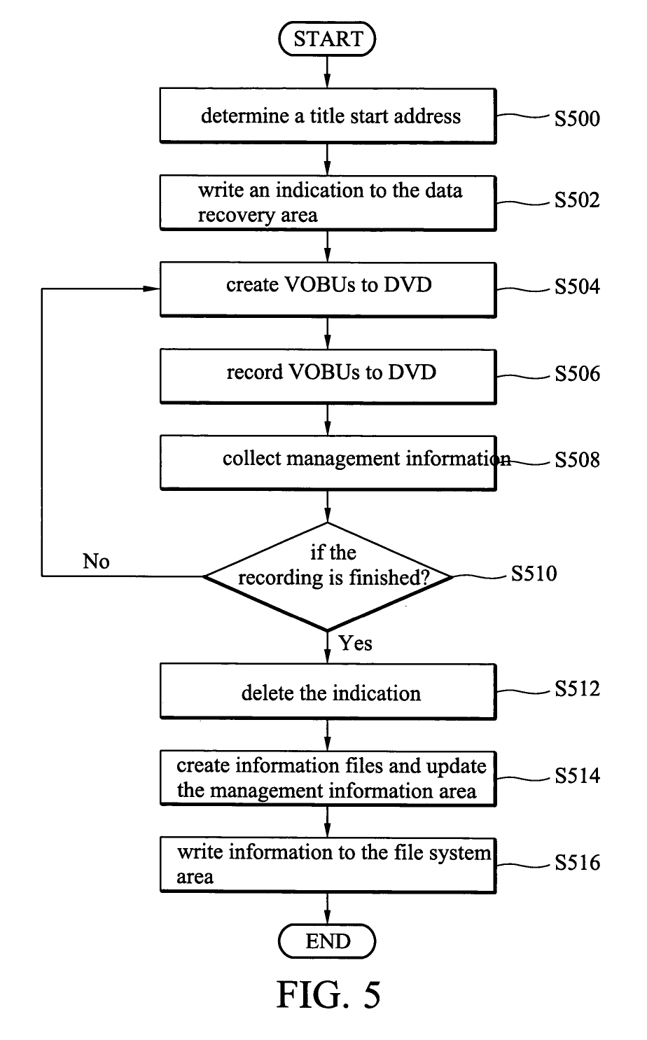

FIG. 5 is a flowchart of an embodiment of a data recording method for rewritable disks. When a rewritable disk is inserted in a recorder for multimedia data recording, a title start address, corresponding to a title, of the rewritable disk is determined (step S500). The rewritable disk is formatted according to DVD+RW or DVD−RW standards. The rewritable disk contains a file system area, a management information area, a data recovery area, and VOBs. The data recovery area could be located in an unused area of the rewritable disk. The unused area could be the same as defined by DVD+RW or DVD−RW standards. An indication is written to the data recovery area based on the title start address (step S502). For example, the indication can be the title start address or a signal to indicate the recording situation, such as recording successful or fail.

If the indication is the title start address, the indication can be retrieved directly for recovery. If the indication is a signal, the indication can be retrieved and interpreted for recovery.

Multimedia data is then recorded to the VOBs. For data recording, the multimedia data is compressed into video object units (VOBUs) (step S504). The VOBUs are recorded onto the rewritable disk according to the title start address (step S506). Management information is collected from the recorded video object units (step S508). Management information includes first information for the management information area and second information for the file system area. The first information is collected mainly from the VOBUs to generate information files and may include, for example, video manager information (VMGI) and video title set information (VTSI) The second information may include the updated and other system information related to the recorded data.

If the multimedia data recording is finished (step S510), the indication is deleted from the data recovery area. If not, go to step S504. After the indication is deleted, the management information is recorded to the management information area (step S514). The management information is also recorded to the file system area (step S516). AS mentioned, the management information includes first information for the management information area and second information for the file system area. The management information is collected in step S508, information files are then created according to the collected management_information. The information files may include video manager information (VMGI), video title set information (VTSI), and program chain information files (PGCI). The management information area is updated using the created information files. The second information is created according to the updated management information area and the VOBs. The created second information is written to the file system area.

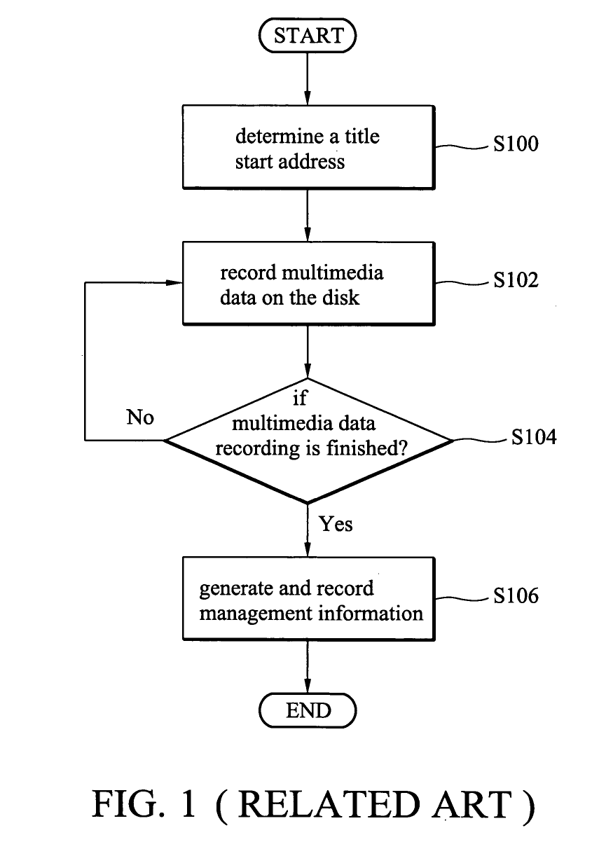

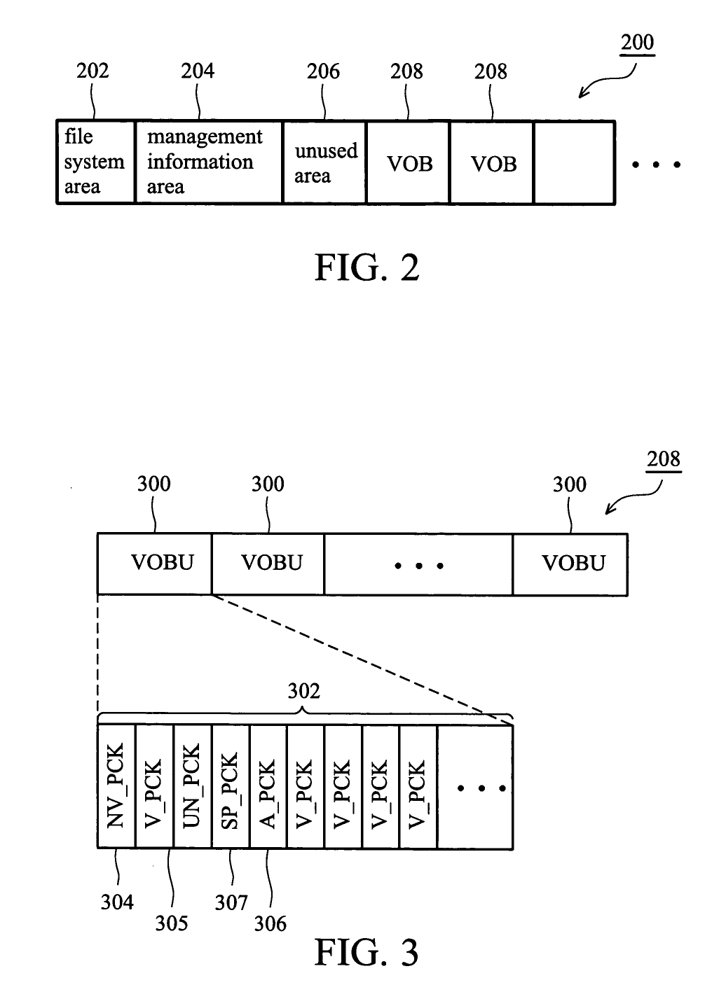

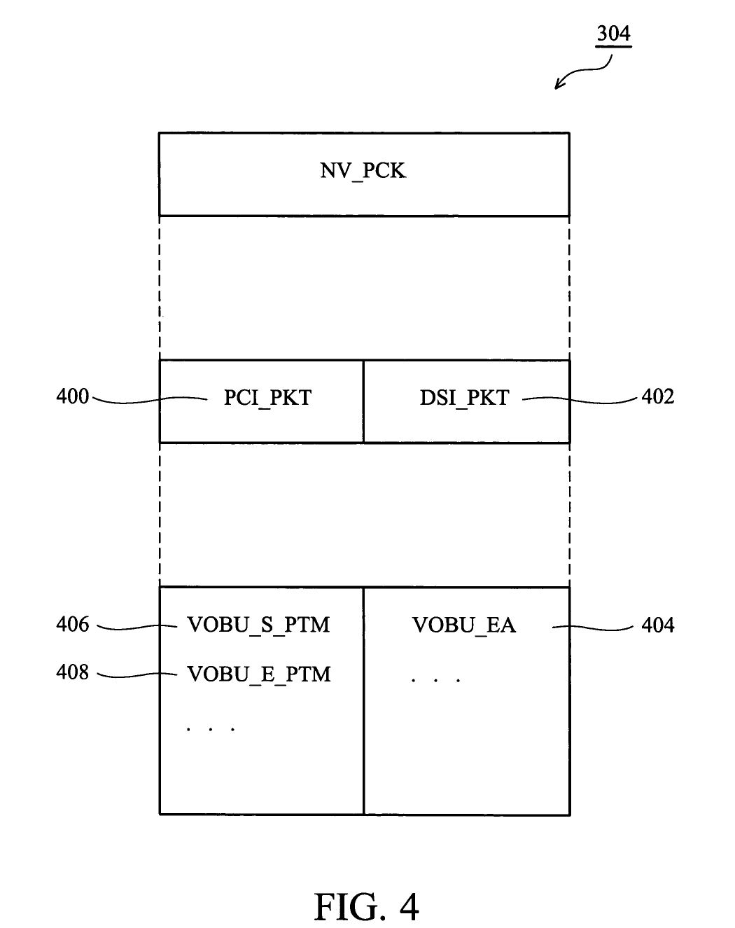

Comparing FIG. 1 and FIG. 5, an indication is written to a reserved area of the rewritable disk for data recovery in FIG. 5. Thus, if unexpected termination occurs during data recording (for example, due to power failure), the indication is left in the data recovery area. Later on, the indication can be used for data recovery.

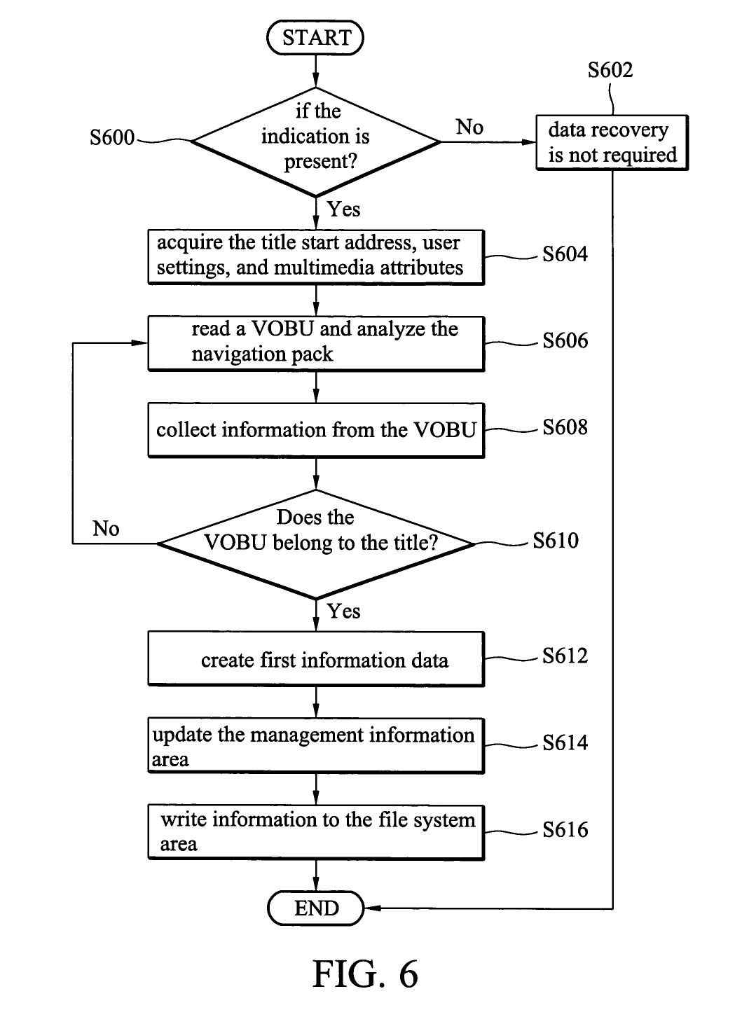

FIG. 6 is a flowchart of an embodiment of a data recovery method for rewritable disks. The indication is sought (step S600). If no indication is present, data recovery is not required (step S602) If so, recovery procedure is not executed. The title start address corresponding to a title is acquired from the recovery data area based on the indication (step S604). In some applications, the indication can be the title start address. Additionally, user settings and multimedia attributes are also obtained from the data recovery area. Pack data of VOBUs belonging to the title are analyzed from the VOBs (step S606). Each VOBU includes a navigation pack storing unit information.

The unit information is collected (step S608). Reading and collection are continued until the analyzed VOBU does not belong to the same title. Here, it is determined whether the analyzed VOBU does belong to the title (step S610). The determination can be accomplished by checking if the first pack of a VOBU is a navigation pack, and if an end pointer of a previous VOBU and a start pointer of a posterior VOBU are sequential. The end pointer and start pointer are parameters recorded in a VOBU.

The collected unit information and the obtained user settings; and multimedia attributes are analyzed to create the first information (step S612). The management information area is updated using the first information (step S614). The second information is created according to the updated management information area and the analyzed unit information. The second information is written to the file system area (step S616).

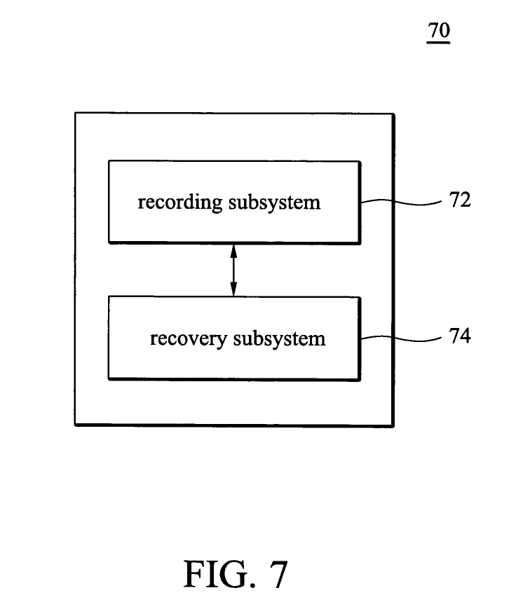

FIG. 7 is a diagram of an embodiment of a data recording system for rewritable disks. A data recording system 70 for rewritable disks includes a recording subsystem 72 and a recovery subsystem 74. The recording subsystem 72 records multimedia data to a rewritable disk, and the rewritable disk may be formatted according to DVD−RW or DVD+RW standards. The recovery subsystem 74 is capable of recovering the multimedia data if the multimedia data recording is terminated unexpectedly.

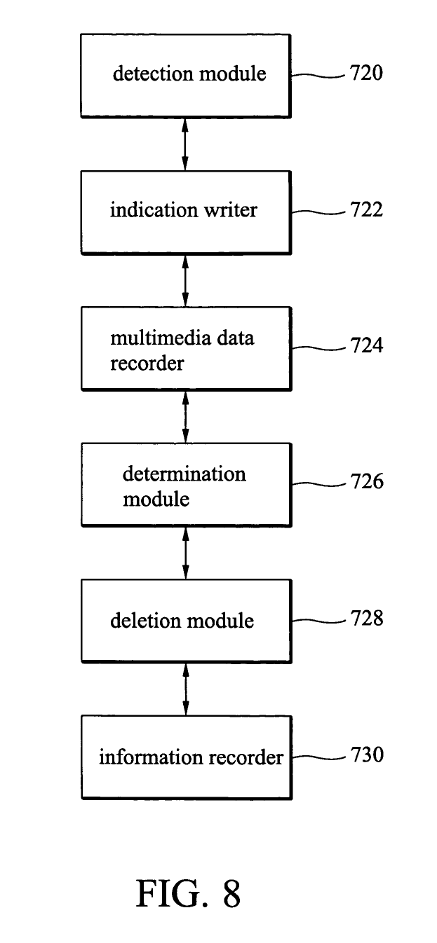

FIG. 8 is a detailed diagram of an embodiment of a recording subsystem of a data recording system. The recording subsystem 72 includes a detection module 720, an indication writer 722, a multimedia data recorder 724, a determination module 726, a deletion module 728, and a management information recorder 730.

The detection module 720 determines a title start address of a rewritable disk. The rewritable disk contains a file system area, a management information area, a data recovery area, and VOBs. The data recovery area may be located in an unused area of the rewritable disk The indication writer 722 writes an indication to the data recovery area based on the title start address.

The multimedia data recorder 724 records multimedia data to the VOBs. For data recording, the multimedia data recorder 724 further compresses the multimedia data into video object units (VOBUs), records the VOBUs to the rewritable disk according to the title start address, and collects management information from the recorded VOBUs. Here, the management information includes first information for the management information area and second information for the file system area.

The determination module 726 determines if the multimedia data recording is finished. The deletion module 728 deletes the indication from the data recovery area if the multimedia data recording is finished.

The management information recorder 730 records management information to the management information area and the file system area. For management information recording, the management information recorder 730 creates information files according to the first information, updates the management information area using the created information files, creates the second information according to the updated management information area and the VOBs, and writes the second information to the file system area. The information files may include video manager information, video title set information, and program chain information files.

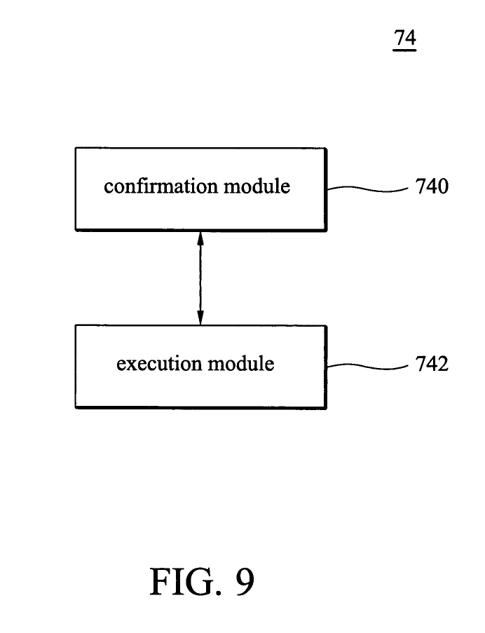

FIG. 9 is a detailed diagram of an embodiment of a recovery subsystem of a data recording system. The recovery subsystem 74 comprises a confirmation module 740 and an execution module 742. The confirmation module 740 confirms the presence of an indication. The execution module 742 executes a recovery procedure if so.

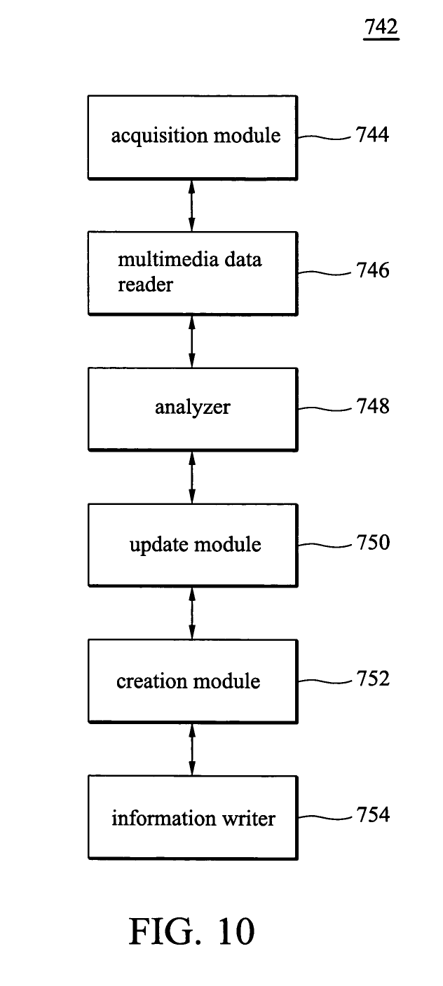

FIG. 10 is a detailed diagram of an embodiment of an execution module of a recovery subsystem of a data recording system. The execution module 742 further includes an acquisition module 744, a multimedia data reader 746, an analyzer 748, an update module 750, a creation module 752, and a management information writer 754.

The acquisition module 744 acquires the title start address from the recovery data area based on the indication. For example, the title start address can be calculated based on the indication. The multimedia data reader 746 reads the pack data of VOBUs belonging to the title from the VOBs. Each VOBU includes a navigation pack or user defined packs. Thus, the multimedia data reader 746 further determines if the VOBUs belong to the title. The multimedia data reader 746 accomplishes the determination by checking if the first pack of a VOBU is a navigation pack, and if an end pointer of a previous VOBU and a start pointer of a posterior video data unit are sequential.

The analyzer 748 analyzes the unit information, user settings, and multimedia attributes to create the first information for the management information area, wherein the user settings and multimedia attributes are obtained from the data recovery area.

The update module 750 updates the management information area using the first information. The creation module 752 creates the second information according to the updated management information area and the unit information. The management information writer 754 writes the second information to the file system area.

Thus, provided data recording methods and systems for rewritable disks resolve unexpected termination problems, and enable recovery of data from unexpected termination.

Methods and systems of the present disclosure, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

1. A data recording method for rewritable disks, comprising:
determining a title start address of a rewritable disk, wherein the rewritable disk comprises a file system area, a management information area, a data recovery area, and at least one video object set (VOB);
writing an indication to the data recovery area based on the title start address;
recording multimedia data to the VOBs;
determining if the multimedia data recording has finished;
deleting the indication from the data recovery area if the multimedia data recording has been finished; and
recording management information to the management information area and the file system area, wherein the management information comprises first information for the management information area and second information for the file system area.

2. The data recording method for rewritable disks as claimed in claim 1, wherein the multimedia data recording comprises:
compressing the multimedia data into video object units (VOBUs);
recording the VOBUs to the rewritable disk based on the title start address; and
collecting the first information from the recorded VOBUs.

3. The data recording method for rewritable disks as claimed in claim 2, wherein the management information recording comprises:
creating information files according to the collected first information;
updating the management information area using the created information files;
creating the second information according to the updated management information area and the VOBs; and
writing the second information to the file system area.

4. The data recording method for rewritable disks as claimed in claim 3, wherein the information files comprise video manager information, video title set information, and program chain information files.

5. The data recording method for rewritable disks as claimed in claim 2, further comprising:
confirming the presence of the indication; and
executing a recovery procedure if the indication is present.

6. The data recording method for rewritable disks as claimed in claim 5, wherein the recovery procedure comprises:
acquiring the title start address corresponding to a title from the recovery data area based on the indication;
reading pack data of the VOBUs from the VOB belonging to the title, wherein each VOBU comprises a navigation pack storing unit information;
analyzing the unit information, user settings, and multimedia attributes to create the first information, wherein the user settings and multimedia attributes are obtained from the data recovery area;
updating the management information area using the first information; and
creating the second information according to the updated management information area and the analyzed unit information;
writing the second information to the file system data area.

7. The data recording method for rewritable disks as claimed in claim 6, further determining if the VOBUs belong to the title.

8. The data recording method for rewritable disks as claimed in claim 7, wherein the determination is accomplished by checking if the first pack of a VOBU is a navigation pack.

9. The data recording method for rewritable disks as claimed in claim 7, wherein the determination is accomplished by checking if an end pointer of a previous VOBU and a start pointer of a posterior VOBU are sequential.

10. The data recording method for rewritable disks as claimed in claim 1, wherein the rewritable disk is formatted according to DVD+RW specifications.

11. The data recording method for rewritable disks as claimed in claim 1, wherein the rewritable disk is formatted according to DVD−RW specifications.

12. A data recording system for rewritable disks, comprising:
a recording subsystem, recording multimedia data to a rewritable disk; and
a recovery subsystem, coupled to the recording subsystem, recovering the multimedia data if the multimedia data recording has finished unexpectedly.

13. The data recording system for rewritable disks as claimed in claim 12, wherein the recording subsystem comprises:
a detection module, determining a title start address of a rewritable disk, wherein the rewritable disk comprises a file system area, a management information area, a data recovery area, and at least one video object set (VOB);
an indication writer, coupled to the detection module, writing an indication to the data recovery area based on the title start address;
a multimedia data recorder, coupled to the indication writer, recording multimedia data to the VOBs;
a determination module, coupled to the multimedia data recorder, determining if the multimedia data recording has finished;
a deletion module, coupled to the determination module, deleting the indication from the data recovery area if the multimedia data recording has finished; and
an information recorder, coupled to the deletion module, recording management information to the management information area and the file system area, wherein the management information comprises first information for the management information area and second information for the file system area.

14. The data recording system for rewritable disks as claimed in claim 13, wherein the data recorder further compresses the multimedia data into VOBUs, records the VOBUs to the rewritable disk according to the title start address, and collects the first information from the recorded VOBUs.

15. The data recording system for rewritable disks as claimed in claim 14, wherein the information recorder further creates information files according to the first information, updates the management information area using the created information files, creates the second information according to the updated management information area and the VOBs, and writes the second information to the file system area.

16. The data recording system for rewritable disks as claimed in claim 15, wherein the information files comprise video manager information, video title set information, and program chain information files.

17. The data recording system for rewritable disks as claimed in claim 14, wherein the recovery subsystem further comprises:
a confirmation module, confirming the presence of the indication; and
an execution module, coupled to the confirmation module, executing a recovery procedure if the indication is present.

18. The data recording system for rewritable disks as claimed in claim 17, wherein the execution module further comprises:
an acquisition module, acquiring the title start address corresponding to a title from the recovery data area based on the indication;
a multimedia data reader, coupled to the acquisition module, reading the pack data of VOBUs from the VOBs belonging to the title, wherein each VOBU comprises a navigation pack storing unit information;
an analyzer, coupled to the multimedia data reader, analyzing the unit information, user settings, and multimedia attributes to create the first information for the management information area, wherein the user settings and multimedia attributes are obtained from the data recovery area;
an update module, coupled to the analyzer, updating the information file data area using the first information; and
a creation module, coupled to the update module, creating the second information according to the updated management information area and the unit information; and
an information writer, coupled to the creation module, writing the second information to the file system data area.

19. The data recording system for rewritable disks as claimed in claim 18, wherein the reader further determines if the VOBs belong to the title.

20. The data recording system for rewritable disks as claimed in claim 19, wherein the multimedia data reader accomplishes the determination by checking if the first pack of a VOBU is a navigation pack.

21. The data recording system for rewritable disks as claimed in claim 19, wherein the multimedia data reader accomplishes the determination by checking if an end pointer of a previous VOBU and a start pointer of a posterior VOBU are sequential.

22. The data recording system for rewritable disks as claimed in claim 12, wherein the rewritable disk is formatted according to DVD+RW specifications.

23. The data recording system for rewritable disks as claimed in claim 12, wherein the rewritable disk is formatted according to DVD−RW specifications.
